(19) United States
(12) Patent Application Publication
(10) Pub. No.: US 2019/0156537 A1
(43) Pub. Date: May 23, 2019

(54) METHOD OF DIGITAL DESIGN GENERATION

(71) Applicant: LOGOJOY INC., Toronto (CA)

(72) Inventor: Rares CRISAN, Toronto (CA)

(21) Appl. No.: 15/819,806

(22) Filed: Nov. 21, 2017

(51) Int. Cl. G06T 11/60; G06T 11/00; G06T 3/40

(52) U.S. Cl. CPC G06T 11/60; G06T 3/40; G06T 11/001

(57) ABSTRACT

A method for digital design generation employing variation based design to preserve dominant qualities and characteristics of a base design is provided. The method includes generating the base design, receiving a selection indicating selected features to be varied and static features to be maintained, defining variation rules, and generating variant designs based on the variation rules. In some implementations, the designs may be generated by defining a canvas, defining a first element, applying a scaling factor, adjusting color, and applying positioning constraints. Further, a method for positioning vector graphics files to maintain relative spacing and positioning of elements is provided. The method includes defining a root layout having root cells, assigning the first vector graphic element to a first parent cell, and instructing the first vector graphic element to be aligned within the first parent cell. In other implementations, the method may include defining node layouts nested in parent cells.

### FIELD OF THE INVENTION

The present disclosure relates generally to digital design generators, and more particularly to a method of digital design generation employing variation based design.

### BACKGROUND

When designing a logo, professional human designers work with a client to understand their preferences and help the client discover the components of their vision. However, this design process is costly and time-consuming. Digital design generators address this shortcoming. Digital design generators or digital logo generators utilize templates which fit the content to a template. One example of such a template-based design generator is Logaster.

With template based design, clients pick a template and can change the features of that template. It can be difficult for clients to compare different templates as they can vary substantially. Further, templates may be restrictive when it comes to altering elements of the template.

### SUMMARY

The present disclosure provides a method of digital design generation employing variation based design, wherein features are adjusted based on the original design to preserve the dominant qualities of the design. Further, the system and method disclosed does not use templates, but rather fits the elements to the design specifications. Changes in the properties of the elements are then carried through and reflected in the variations as well.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” can be construed as X only, Y only, Z only, or any combination of two or more items X, Y, and Z (e.g., XYZ, XY, YZ, ZZ, and the like). Similar logic can be applied for two or more items in any occurrence of “at least one . . . ” and “one or more . . . ” language.

According to an aspect of this disclosure, a method for generating digital designs is provided. The method includes at a processor, generating a base design having a main canvas and a first vector graphic element, the main canvas having a first feature, and the first vector graphic element having a second feature; receiving a selection defining selected features to be varied, and static features to be maintained; defining variation rules for varying selected features and maintaining the static features; and generating one or more variant designs according to the variation rules.

In some implementations, the first vector graphic element is an icon, and the second feature is one of size, color and image. In some implementations, the first vector graphic element is a text element and the second feature is one of size, color and font. In some implementations, the first vector graphic element is a monogram and the second feature is one of size color and style. In some implementations, the first vector graphic element is a container element and the second feature is one of size, color and image.

In some implementations, the first feature is one of color and layout.

In some implementations, generating the base design includes defining the main canvas; defining the first vector graphic element; applying a scaling factor to the first vector graphic element; adjusting a color of the main canvas and the first vector graphic element according to a contrast ratio; and applying positioning constraints to the first vector graphic element.

In some implementations, generating a variant design comprises defining a variant canvas based on the main canvas of the base design and according to the variation rules; defining at least one variant vector graphic element based on the first vector graphic element of the base design and according to the variation rules; applying a scaling factor to the at least one variant vector graphic element according to the variation rules; adjusting a color of the variant canvas and the at least one variant vector graphic element according to a contrast ratio and according to the variation rules; and applying positioning constraints to the at least one variant vector graphic element according to the variation rules.

In some implementations, the method further comprises receiving a data transmission containing component information for defining components of the base design and the variant designs; and a control application for generating the base design and the variant designs and defining the variation rules.

According to another aspect of the disclosure, a non-transitory computer readable medium for storing a computer program is provided. The execution of the computer program is for generating a base design having a main canvas and a first vector graphic element, the main canvas having a first feature, and the first vector graphic element having a second feature; receiving a selection defining selected features to be varied and static features to be maintained; defining variation rules for varying the selected features and maintaining the static features; and generating one or more variant designs according to the variation rules.

According to another aspect of the disclosure, a method of applying positioning constraints to a first vector graphic element in a vector graphic file is provided. The method comprises defining a root layout having at least one root row and at least one root column defining root cells; assigning the first vector graphic element to a first parent cell selected from the root cells; and instructing the first vector graphic element to be aligned within the first parent cell.

In some implementations, the method further comprises assigning a second vector graphic element to a second parent cell selected from the root cells, wherein the first parent cell is distinct from the second parent cell.

In some implementations, the method further comprises defining a node layout within a root cell, the node layout having at least one node row and at least one node column defining node cells, wherein the parent cell of the first vector graphic element is selected from the root cells and the node cells.

In some implementations, the method further comprises assigning a second vector graphic element to a second parent cell selected from the root cells and the node cells, wherein the first parent cell is distinct from the second parent cell; and instructing the second vector graphic element to be aligned within the second parent cell.

In some implementations, the method further comprises receiving an alignment indication and wherein the instructing comprises instructing the first vector graphic element to be aligned within the first parent cell according to the alignment indication.

In some implementations, the method further comprises calculating X,Y coordinates for the first vector graphic element according to dimensions of the first vector graphic element and dimensions of the first parent cell and according to the alignment indication; and applying the X,Y coordinates as a transform property of the first vector graphic element.

### BRIEF DESCRIPTION OF DRAWINGS

FIG. 1 shows a system for digital design generation in accordance with the present disclosure.

FIG. 2 shows a control application of the system for digital design generation of FIG. 1.

FIG. 3 shows a method for digital design generation in accordance with the present disclosure.

FIG. 4A shows a digital design.

FIG. 4B shows three variant digital designs of FIG. 4A.

FIG. 4C shows a further three variant digital designs of FIG. 4A.

FIG. 4D shows still further three variant digital designs of FIG. 4A.

FIG. 5 shows a method for generating a base design in accordance with the present disclosure.

FIG. 6 shows a method for generating a variant design in accordance with the present disclosure.

FIG. 7 shows a method for applying positioning constraints to vector graphic files in accordance with the present disclosure.

FIG. 8 shows a schematic of positioning components for the digital design of FIG. 4A.

FIG. 9 shows a schematic of positioning components for one of the digital designs of FIG. 4C.

FIG. 10 shows a diagram of a tree hierarchy of a root layout and node layouts in accordance with the present disclosure.

### DETAILED DESCRIPTION

The present disclosure provides a system and method for digital design generation employing variation based design. The variation based design method allows a user to change selected features while maintaining other features. Thus the dominant qualities and characteristics of the design are maintained, allowing a user to visualize and understand the overall effect of each individual change. The present disclosure also provides for flexible templates, so that the content of each element in the template can be altered while maintaining the dominant spacing and positioning features of the elements in the space, and giving the elements awareness of each other.

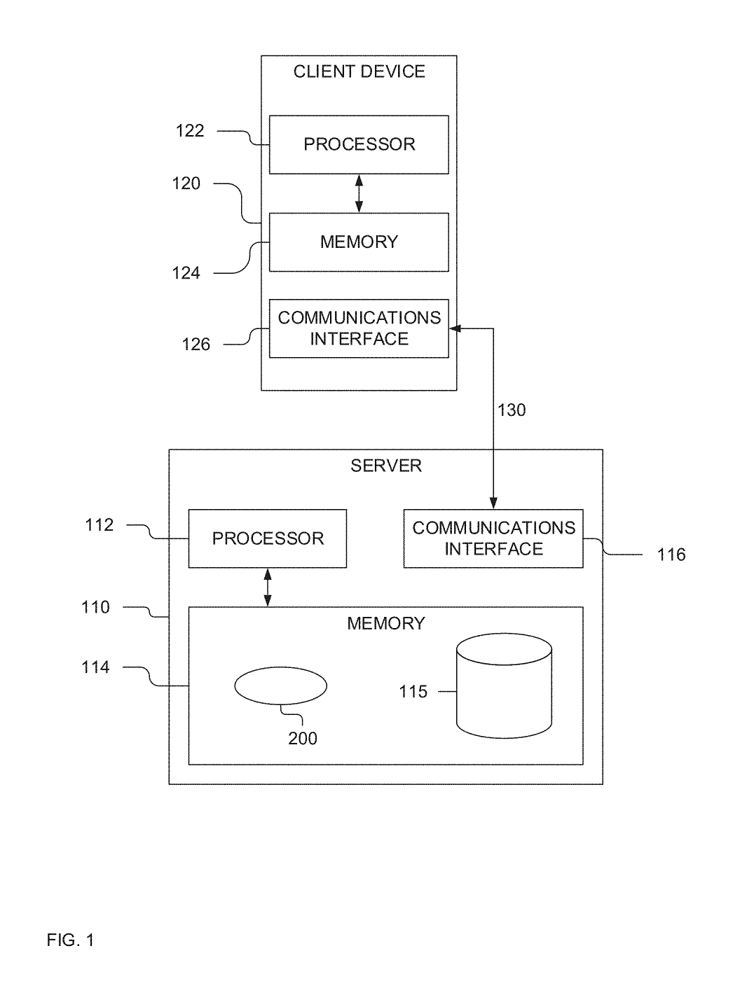

FIG. 1 shows a system 100 for digital design generation in accordance with the present disclosure. The system 100 includes a server 110 in communication with at least one client device 120 via communication links 130.

The server 110 includes a processor 112, specifically configured to generate digital designs (also referred to herein simply as designs). The processor 112 may include a central-processing unit (CPU), a microcontroller, a microprocessor, a processing core, a field-programmable gate array (FPGA), or similar. The processor may include multiple cooperating processors. The processor 112 may cooperate with a non-transitory computer readable medium such as a memory 114 to execute instructions to realize the functionality discussed herein. The memory 114 may include a combination of volatile (e.g. Random Access Memory or RAM) and non-volatile memory (e.g. read only memory or ROM, Electrically Erasable Programmable Read Only Memory or EEPROM, flash memory). All or some of the memory 114 may be integrated with the processor 112. The memory 114 stores computer readable instructions for execution by the processor 112.

In particular, the memory 114 stores a plurality of applications, each including a plurality of computer readable instructions executable by the processor 112. The execution of the instructions by the processor 112 configures the server 110 to perform various actions discussed herein. The applications stored in the memory 114 include a control application 200 which may also be implemented as a suite of logically distinct applications. In general, via execution of the control application 200 or subcomponents thereof, the processor 112 is configured to implement various functionalities as described herein The memory 114 also stores a library of component information 115 (also referred to herein as component information 115) for defining selectable components of a design.

The server 110 also includes a communications interface 116 interconnected with the processor 112. The communications interface 116 includes suitable hardware (e.g. transmitters, receivers, network interface controllers and the like) allowing the server 110 to communicate with other computing devices, such as the client device 120, via the communication links 130. The specific components of the communications interface 116 are selected based on the type of network or other links that the server 110 is required to communicate over.

The client device 120 may be a computing device such as a desktop computer, a laptop computer, another server, a kiosk, a monitor, or other suitable device. In other examples, the client device 120 includes mobile computing devices, such as a tablet, smart phone or the like. The system 100 can include a plurality of client devices 120, each in communication with the server 110 via respective communication links 130.

The communication links 130 may include internet protocol (IP) networks, such as intranet, a local-area network, a wide-area network, a virtual private network (VPN), a Wi-Fi network, a short-range wireless network (e.g., Bluetooth or Bluetooth Low Energy), the internet, combinations of such, and the like. The communication links 130 may be direct links, or links that traverse one or more networks, including both local and wide-area networks.

The client device 120 may also include a processor 122. The processor 122 may include a central-processing unit (CPU), a microcontroller, a microprocessor, a processing core, a field-programmable gate array (FPGA), or similar. The processor 122 may include multiple cooperating processors. The processor 122 may cooperate with a non-transitory computer readable storage medium, such as a memory 124 to execute instructions to realize the functionality discussed herein. The memory 124 may include a combination of volatile (e.g. Random Access Memory or RAM) and non-volatile memory (e.g. read only memory or ROM, Electrically Erasable Programmable Read Only Memory or EEPROM, flash memory). All or some of the memory 124 may be integrated with the processor 122.

The client device 120 also includes a communications interface 126 interconnected with the processor 122. The communications interface 126 includes suitable hardware (e.g. transmitters, receivers, network interface controllers and the like) allowing the client device 120 to communicate with other computing devices, such as the server 110, via the communication links 130. The communication links 130 may be direct links, or links that traverse one or more networks, including both local and wide-area networks. The specific components of the communications interface 126 are selected based on the type of network or other links that the client device 120 is required to communicate over.

In some implementations, the server 110 may be configured to host a webpage, and the method for digital design generation may be defined by the webpage in a manner that allows the method to be executed by any suitable user agent (web browser) on the client device 120. Suitable user agents include modem web browsers having session storage, such as Mozilla Firefox, Google Chrome, and the like. Thus, the client device may be configured to request copies of the library of component information 115 and the control application 200 via communication links 130. For example, this may be achieved by the client device 120 being used to follow a hyperlink to the webpage, enter a URL of the webpage, or similar. The client device 120 may receive and store a data transmission containing copies of the library of component information 115 and the control application 200 in the browser session storage. The session storage may be temporarily integrated with memory 124 for the duration of the session, and purged at the end of the session. The processor 122 of the client device 120 may read and execute the computer readable instructions stored therein by executing the control application 200.

In the present example, as discussed below, the client device 120 (as configured via the execution of the copy of the control application by the processor 122) is configured to generate digital designs. In further examples, the digital design generation may be performed by the server 110, or on a computing device other than the server 110 and the client device 120.

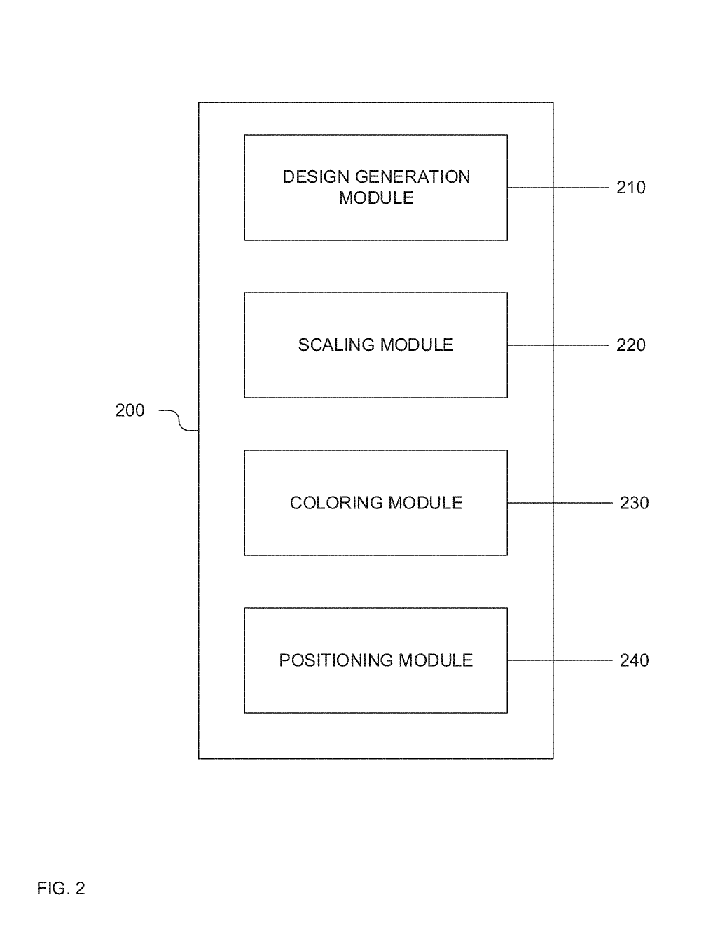

FIG. 2 shows the control application 200. The control application 200 includes a design generation module 210 configured to define components of the design to generate the design. The control application further includes a scaling module 220 configured to determine and apply scaling factors to the components, a coloring module 230 configured to determine contrast ratios between components and apply coloring factors to the components, and a positioning module 240 configured to determine positioning relationships between components and to apply positioning constraints to components.

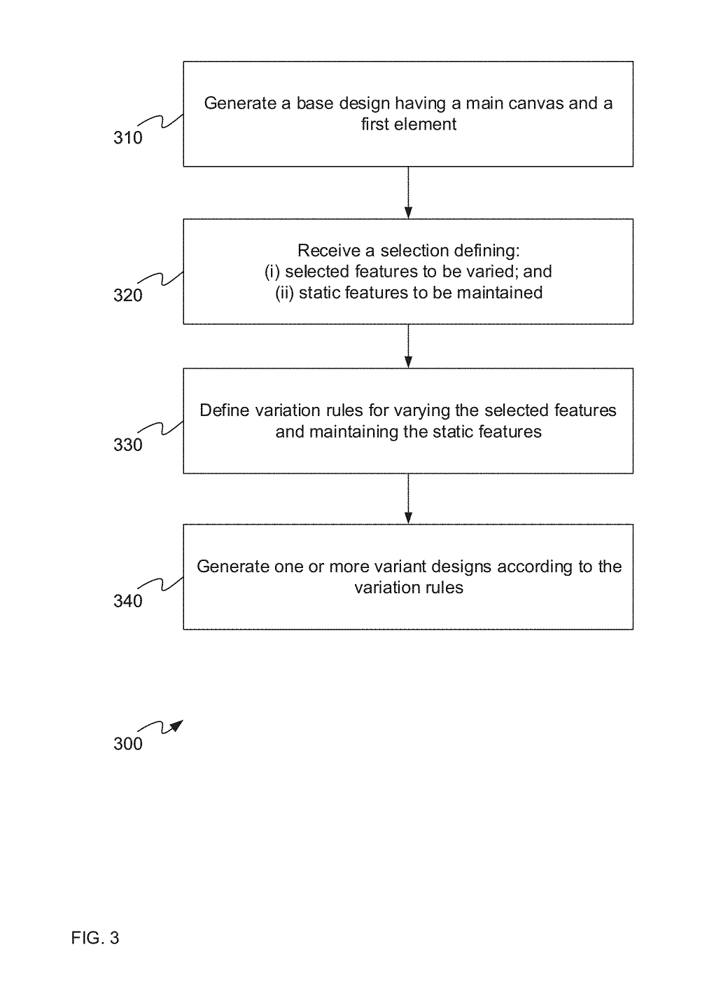

Turning now to FIG. 3, a method 300 of digital design generation is shown. The method 300 will be described in conjunction with its performance on the system 100. In the present example, the client device 120 may be configured to generate digital designs. In other examples, other suitable systems may perform the method 300.

At block 310, the processor 122 generates a base design having a main canvas and a first element. The main canvas has a first feature, and the first element has a second feature.

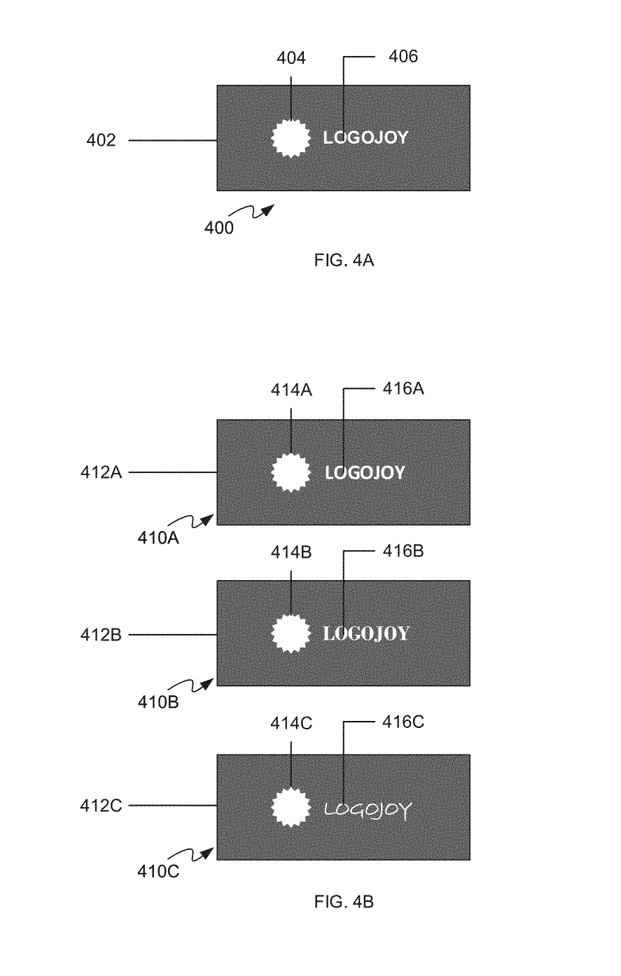

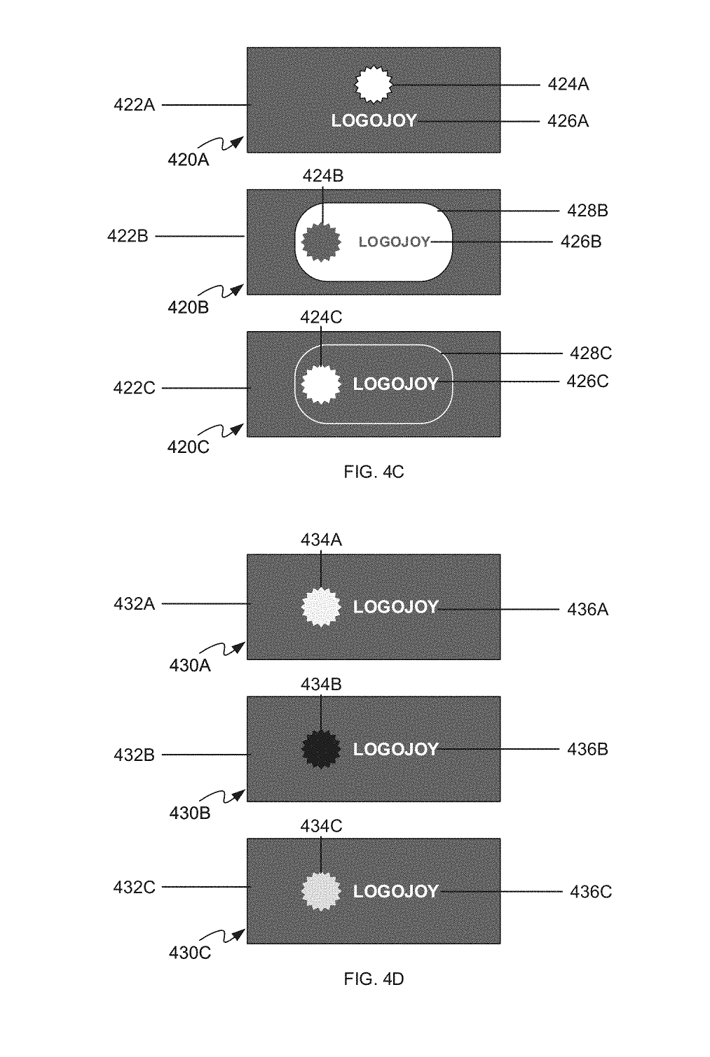

An example base design 400 is illustrated in FIG. 4, depicting a main canvas 402 and a first element 404, which is an icon. The main canvas 402 includes the feature of color. The first element 404 includes the features of size, color, and image.

In some examples, the main canvas 402 may include other features, such as layout and size. In other examples, the first element 404 may be text having the features of size, color and font. In further examples, the first element 404 may be a monogram having the features of size, color and style. In still further examples, the first element 404 may be a container having the features of size, color, and image. In some examples, the base design 400 may have further elements such as text element 406.

In some implementations, the first element 404 may be a vector graphic element. Thus, for example, the first element 404 may be a vector graphic element describing an icon. The associated vector graphic file for the first element 404 defines the image or design of the icon as a set of vectors to be drawn. For example, the vector graphic file may define the image to be a star, or a book, or any other suitable desired image. The vector graphic file for the first element 404 may further define properties of the icon, such as the size and color of the icon.

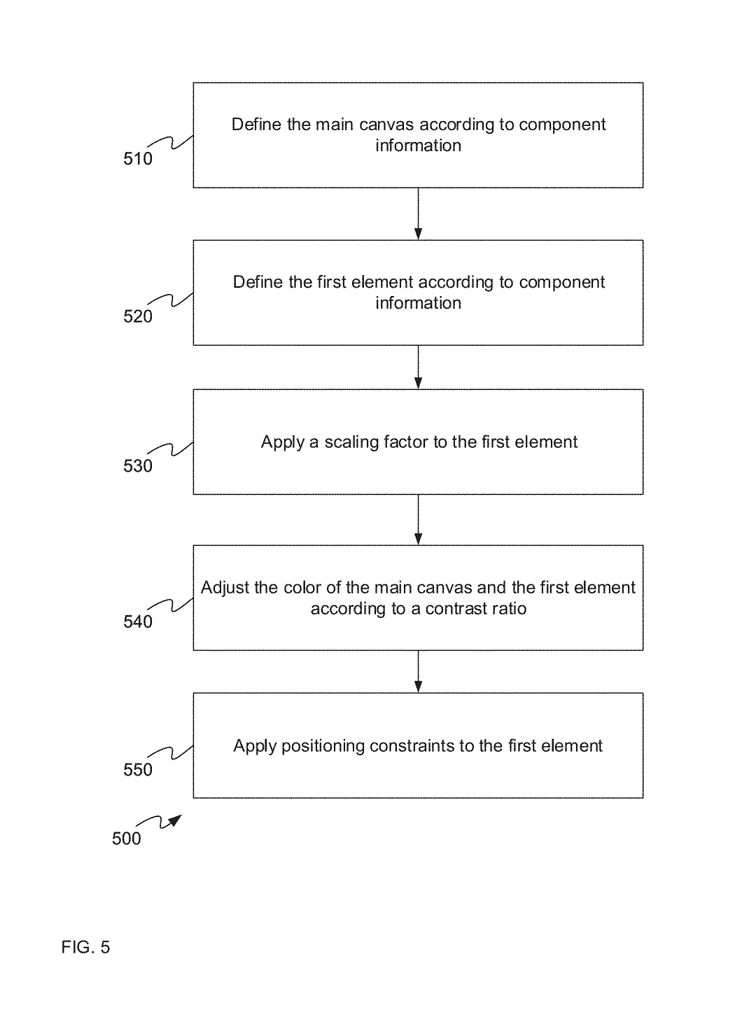

Referring now to FIG. 5, a method 500 for generating the base design 400 is shown.

At block 510, the processor 122, and particularly the design generation module 210 defines the main canvas 402 according to component information 115 stored in memory 114.

At block 520, the processor 122, and particularly the design generation module 210 defines the first element 404 (also referred to herein as icon 404) according to component information 115 stored in memory 114. Where the base design 400 has more than one element, the design generation module 210 may also define further elements such as text element 406.

In some implementations, the design generation module 210 may generate a vector graphics file defining the design. Thus, the design generation module 210 may define the main canvas 402, the icon 404 and further text element 406 by defining vector graphics paths of the main canvas 402, the icon 404 and further text element 406 in the vector graphics file.

At block 530, the processor 122, and particularly the scaling module 220, applies a scaling factor to the icon 404. In particular, the scaling module 220 may apply the scaling factor as an attribute of the vector graphic path for the icon 404.

At block 540, the processor 122, and particularly the coloring module 230, adjusts the color of the main canvas 402 and the icon 404 according to a contrast ratio. In particular, the coloring module 230 may assign a color and fill as an attribute of the vector graphic path for the first element 404 and the main canvas 402.

For example, the coloring module 230 may calculate the contrast ratio in consideration of the relative luminance of the element and the relative luminance of background pixels. In some examples, the coloring module 230 may further employ a lightness calculation to determine if a color needs to be adjusted and in which direction (light or dark). In some examples, the coloring module 230 may adjust the color of the main canvas 402 or the icon 404 to achieve a contrast ratio of 4.5 to improve readability. In other implementations, the minimum contrast ratio may be lower or higher.

At block 550, the processor 122, and particularly the positioning module 240, applies positioning constraints to the first element. In particular, the positioning module may output X,Y coordinates as discussed further below to apply as an attribute of the vector graphic path for the first element 404.

Returning to FIG. 3, at block 320, the processor 122 receives a selection defining (i) selected features to be varied and (ii) static features to be maintained. The selection defines each of the features of the elements and the main canvas as either a selected feature to be varied or a static feature to be maintained. In some examples, the control application 200 may restrict the selected features to a single selected feature to be varied. In other examples, the control application 200 may define restrictions as to which features may be selected simultaneously as selected features to be varied.

For example, the selection may define the color of the icon 404 as the single selected feature to be varied, and the remaining features (i.e. size and image of the icon 404, and color of the main canvas 402) as the static features to be maintained. In another example, the selection may define the color of the icon 404, and the color of text element 406 as the selected features to be varied, and the remaining features as the static features to be maintained. The control application 200, may, for example, define restrictions to disallow the simultaneous selection of the color of the icon 404 and the color of the main canvas 402 as the selected features to be varied.

At block 330, the processor 122 defines variation rules for varying the selected features and maintaining the static features. The variation rules define modification guidelines for the modules of the control application 200 to apply changes to the base design to generate the one or more variant designs.

Referring to FIG. 4B, an example of three variant designs 410A, 410B, and 410C (referred to collectively as variant designs 410) is shown. The variant designs 410 have variant canvases 412A, 412B, and 412C (collectively, variant canvases 412), variant icons 414A, 414B, and 414C (collectively, variant icons 414), and variant text elements 416A, 416B, and 416C (collectively, variant text elements 416). The selection defines the font of text element 406 of the base design 400 as the single selected feature to be varied, and the remaining features to be maintained. Thus, the variation rules may define possible fonts for application by the design generation module 210 when it generates variant text elements 416.

Referring to FIG. 4C, an example of three variant designs 420A, 420B, and 420C (referred to collectively as variant designs 420) is shown. The variant designs 420 have variant canvases 422A, 422B, and 422C (collectively, variant canvases 422), variant icons 424A, 424B, and 424C (collectively, variant icons 424), and variant text elements 426A, 426B, and 426C (collectively, variant text elements 426). The selection defines the layout of the main canvas 402 of the base design 400 as the selected feature to be varied, and the remaining features to be maintained. Thus the variation rules may define possible new container elements 428B and 428C to be incorporated into the design for application by the design generation module 210. The variation rules may further define different or new positioning relationships for application by the positioning module 240. The variation rules may further define options for the coloring module 230 to invert color and preserve competing contrasts where new elements or the new layout constraints may make the existing elements invisible or difficult to see against.

Referring to FIG. 4D, an example of three variant designs 430A, 430B, and 430C (referred to collectively as variant designs 430) is shown. The variant designs 430 have variant canvases 432A, 432B, and 432C (collectively, variant canvases 432), variant icons 434A, 434B, and 434C (collectively, variant icons 434), and variant text elements 436A, 436B, and 436C (collectively, variant text elements 436). The selection defines the color of the icon 404 as the single selected feature to be varied and the remaining static features to be maintained. Thus, the variation rules may define a particular hue or range of hues for the icon 404 for application by the coloring module 230.

At block 340, the processor 122 generates one or more variant designs according to the variation rules.

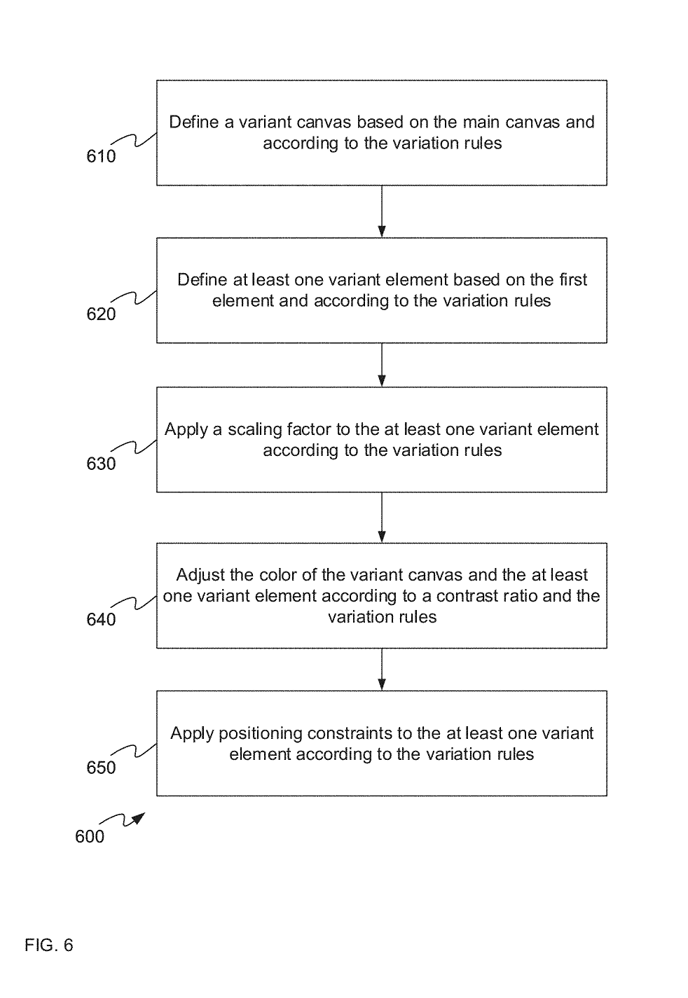

Referring now to FIG. 6, a method for generating variant designs is shown.

At block 610, the processor 122, and particularly the design generation module 210, defines a variant canvas based on the main canvas 402 of the base design 400, and according to the variation rules.

At block 620, the processor 122, and particularly the design generation module 210 defines at least one variant element based on the first element 404 of the base design 400, and according to the variation rules. Generally, design generation module 210 defines the variant elements based on the equivalent element of the base design 400.

For example, referring again to FIG. 4B, the design generation module 210 defines the variant icons 414 based on the icon 404 of the base design 400. In the present example, the features of icon 404 are defined in the selection as static features, thus the features such as the image, size and color of the icon 404 are maintained in the variant icons 414. In contrast, the font of the text element 406 is defined in the selection as a selected feature, thus the modification rules may define different fonts for the variant text elements 416 for application by design generation module 210. For example, design generation module 210 may assign the different fonts as an attribute of the vector graphics paths for the variant text elements 416.

In another example, referring now to FIG. 4C, the design generation module 210 defines the variant text elements 426 based on the text element 406 of the base design 400. In this example, the features of text element 406 are defined in the selection as static features, thus the features such as the size, color, and font are maintained in the variant text elements 426. In contrast, the layout of the main canvas 402 is defined in the selection as a selected feature to be varied. In some variations, the variant layouts may comprise new variant elements, thus the modification rules may define new elements, such as containers 428B and 428C for application by design generation module 210. Design generation module 210 may define the new elements according to component information 115 stored in memory 114.

Referring again to FIG. 6, at block 630, the processor 122, and particularly the scaling module 220, applies a scaling factor to the at least one variant element according to the variation rules. Specifically, the scaling module 220 applies a scaling factor to the at least one variant element to match a dimension of the equivalent element of the base design. In some implementations, the scaling factor may be applied to match a vertical dimension, a horizontal dimension, or to otherwise maintain a consistency to the base design. The scaling module 220 may apply the scaling factor as an attribute of the vector graphic path for the at least one variant element.

For example, in FIG. 4B, the variant text elements 416 may be sized differently due to differences in font specifications. Thus, the scaling module 220 may apply different scaling factors to each of the variant text elements 416 to scale the variant text elements 416 to have approximately the same dimensions as the text element 406 of the base design 400.

At block 640, the processor 122, and particularly the coloring module 230, adjusts the color of the variant canvas and the at least one variant element according to a contrast ratio and according to the variation rules. Specifically, as above, the coloring module 230 may calculate the contrast ratio in consideration of the relative luminance of each element and the relative luminance of background pixels. In some examples, the coloring module 230 may further employ a lightness calculation to determine if a color needs to be adjusted and in which direction (light or dark). In some examples, the coloring module 230 may adjust the color of the variant canvas or the variant element to achieve a contrast ratio of 4.5 to improve readability. In other implementations, the minimum contrast ratio score may be lower or higher. The coloring module 230 may assign a color and fill as an attribute of the vector graphic path for the at least one variant element and the variant canvas.

For example, referring again to FIG. 4C, the selection defines the layout of the main canvas 402 as the selected feature to be varied. The selection further defines the color of the main canvas 402, the color of the icon 404 and the color of the text 406 as static features to be maintained. In consideration of all options, the variation rules may therefore define an option for the coloring module 230 to adjust the colors of the icon 404 and the text element 406 in their variant equivalents.

For example, in variant design 420B, a new container element 428B is added as part of the variant layout. In this case, a dark-colored container element 428B would make the container element 428B invisible or difficult to see against the variant canvas 422B. Similarly, a light-colored container element 428B with the light color of the text element 426B would make the text element 426B invisible or difficult to see against the container element 428B. Coloring module 230 may therefore calculate a contrast ratio between the container element 428B and the variant canvas 422B and adjust the color of new container element 428B accordingly. Coloring module 230 may then calculate a contrast ratio between the container element 428B and the variant text element 426B and adjust the color of the variant text element 426B accordingly. Thus the variation rules allow for competing contrasts to be preserved. In some implementations, the variation rules may restrict the color adjustments to color inversions to preserve the dominant colors of the base design 400.

In another example, referring now to FIG. 4D, the selection defines the color of the icon 404 as the selected feature to be varied. The variation rules may define a particular hue or range of hues for the icon 404. The coloring module 230 may adjust the color of the variant icons 434 within that hue or range of hue while adjusting the saturation and the lightness of the color. In some implementations, the variation rules may also allow for color inversions of other components.

At block 650, the processor 122, and particularly the positioning module 240, applies positioning constraints to the at least one variant element according to the variation rules. In particular, the positioning module 240 may output X,Y coordinates to apply as an attribute of the vector graphic path for the at least one variant element.

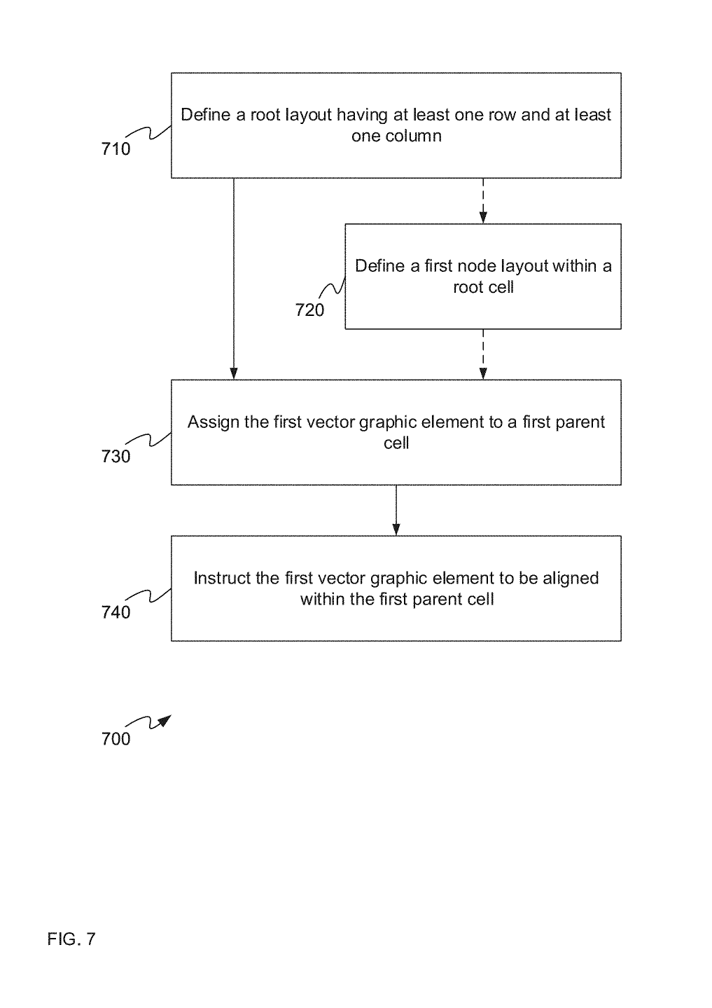

FIG. 7 shows a method 700 for applying positioning constraints to vector graphic files. The method 700 will be described in conjunction with the system 100. In particular, the positioning module 240 may be configured to perform the method 700. In other examples, the method 700 may be performed by control applications or processors separate from the method for digital design generation.

At block 710, a root layout is defined. Specifically, the root layout is defined to include at least one row and at least one column defining root cells.

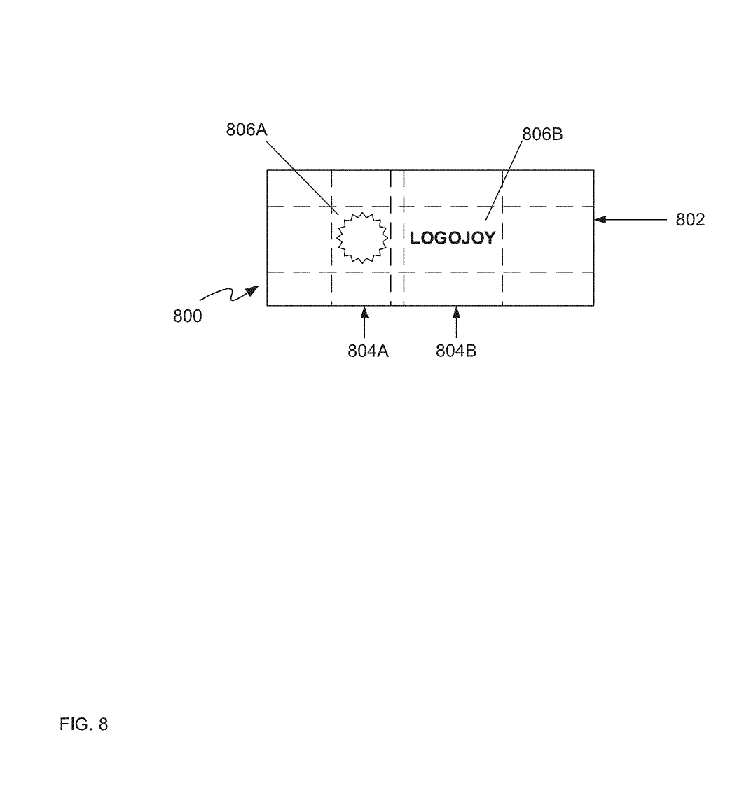

For example, attention is directed to FIG. 8. FIG. 8 shows a schematic of the positioning components of the base design 400. The positioning components include a root layout 800 containing the main canvas 402. Specifically, the root layout 800 is defined to include at least one root row, such as a root row 802, and at least one root column, such as a root column 804A. Together, the root row 802 and the root column 804A define a first root cell 806A. In some examples, the root layout 800 may be defined to include more than one root row, and more than one root column, the root rows and root columns defining further root cells, according to desired layout constraints. For example, the root layout 800 is further defined to include a second root column 804B. Together, the root row 802 and the root column 804B define a second root cell 806B.

Referring again to FIG. 7, at block 720, a first node layout is optionally defined within a root cell, the node layout having at least one node row and at least one node column.

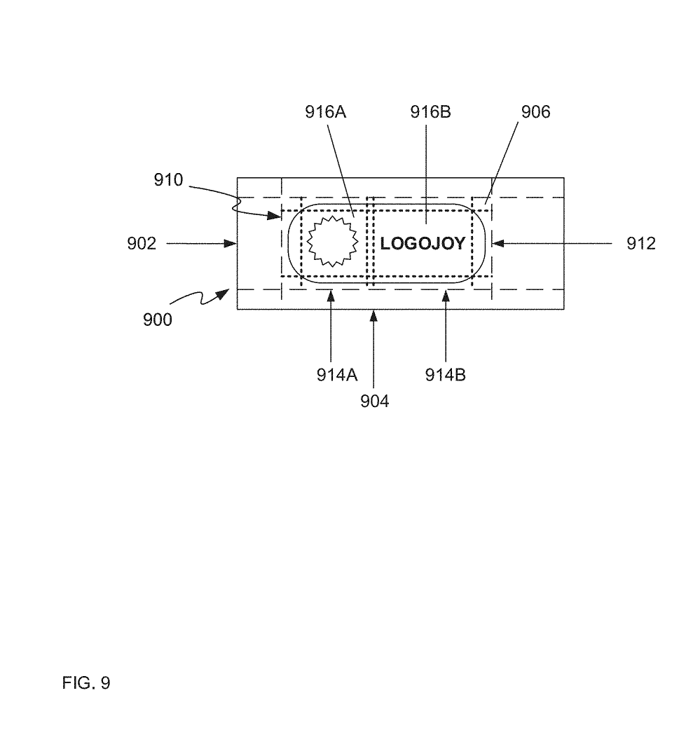

FIG. 9 depicts a schematic of the positioning components of variant design 420B. The positioning components include a root layout 900 containing the main canvas 422B. Specifically, the root layout 900 is defined to include at least one root row, such as a root row 902, and at least one root column, such as a root column 904. Together, the root row 902 and the root column 904 define a root cell 906. The root layout 900 is further defined to include a node layout 910 defined within the root cell 906. The node layout 910 includes a node row 912, and two node columns, 914A and 914B, which define node cells 916A and 916B.

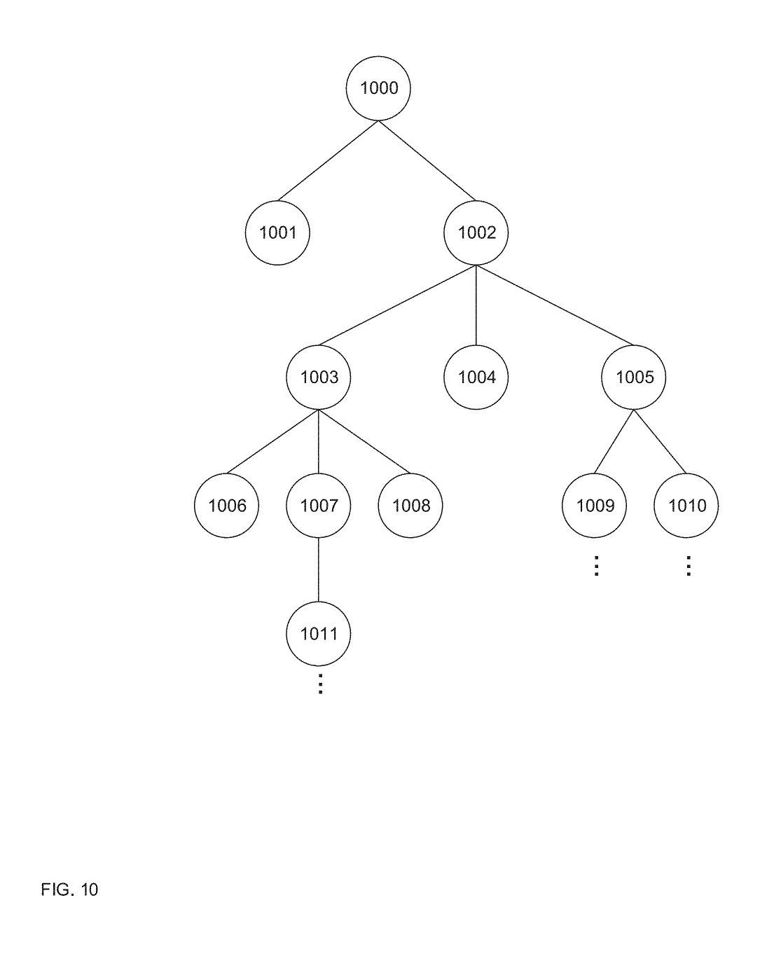

In further examples, the node layouts may also be defined within node cells. The node layouts may form a tree hierarchy, wherein each node layout has at least one, and may have more than one parent-child relationships with another node layout or with the root layout. For example, FIG. 10 depicts a sample tree hierarchy with a root layout 1000, and node layouts 1001-1011. The root layout 1000 is a parent of the child node layouts 1001 and 1002. The node layout 1002 in turn is a parent of the child node layouts 1003, 1004, and 1005. The node layouts may continue to be nested in parent-child relationships to the node layout 1011 and further.

Returning to FIG. 7, at block 730, the first vector graphic element is assigned to a first parent cell. Where the root layout contains only root cells, the parent cell is selected from the root cells. Where the root layout contains root cells and node cells, the parent cell is selected from the root cells and the node cells. Specifically, the first vector graphic element is positionally constrained by dimensions of the parent cell to which it is assigned.

In some examples, a second vector graphic element may be assigned to a second parent cell, wherein the first parent cell is distinct from the second parent cell. In further examples, further vector graphic elements may be assigned to further parent cells, each parent cell distinct from one another. That is, each parent cell contains at most one directly assigned vector graphic element. However, a parent cell may contain a vector graphic element as well as a node layout containing further vector graphic elements, the further vector graphic elements being assigned respective parent cells of the node layout.

In some examples, the assignment of vector graphic elements to parent cells may interact with the definition of the row and column forming the parent cell to define row and column padding and margin attributes.

For example, in FIG. 8, the icon 404 is assigned to the root cell 806A, while the text element 406 is assigned to the root cell 806B. In FIG. 9, the container element 428B is assigned to the root cell 906, which also includes the node layout 910, while the icon 424B is assigned to the node cell 916A and the text element 426B is assigned to the node cell 916B. Since the node layout 910 and the container element 428B share the same parent cell, in consideration of the container element 428B, the node row 912 and the node columns 914A and 914B may be assigned row and column padding and margin attributes such that the node cells 916A and 916B lie within the container element 428B.

Returning again to FIG. 7, at block 740, the first vector graphic element is instructed to be aligned within the first parent cell. For example, the first vector graphic element may be left-, right-, top-, or bottom-aligned, or it may be centered with respect to the first parent cell, or it may be positioned a distance away from edges of the first parent cell. In other examples, the second vector graphic element may be instructed to be aligned within the second parent cell.

In some examples, the positioning module 240 may receive an alignment indication, such as a plain text description of the desired alignment. For example, the alignment indication may be “vertical-center.” Hence, the instructing comprises instructing the first vector graphic element to be aligned within the first parent cell according to the alignment indication. Specifically, the control application 200 may include an instruction set for aligning the first vector graphic element according to the alignment indication. The control application 200 may further include an instruction set for: calculating X,Y coordinates for the first vector graphic element according to dimensions of the first vector graphic element and dimensions of the parent cell and according to the alignment indication; and applying the X,Y coordinates as a transform property of the first vector graphic element. For example, the X,Y coordinates for the first vector graphic element may be calculated using the dimensions of the first vector graphic element and dimensions of the parent cell and applying box-type positioning algorithms.

In further examples, the second vector graphic element may be instructed to be aligned within the second parent cell. Further vector graphic elements may be instructed to be aligned within their respective parent cells. Thus, the method 700 allows for relative positioning of vector graphic files. Specifically, the method 700 allows for designs to be flexible, in that components may be resized, repositioned and otherwise adjusted while maintaining the overall structure, layout, and relative positioning of the design through use of a root-node tree hierarchy. In other implementations, the method may be performed by processors and control applications separate from the method for digital design generation. For example, the method 700 may allow for efficiently applying positioning constraints to vector graphic files in a web browser.

Other embodiments and variations will be apparent to a person of ordinary skill in the art. All such embodiments and variations are believed to be within the scope of the following claims.

1. A method for generating digital designs comprising:
at a processor, generating a base design having a main canvas and a first vector graphic element, the main canvas having a first feature, and the first vector graphic element having a second feature;
at the processor, receiving a selection defining (i) selected features to be varied, and (ii) static features to be maintained;
at the processor, defining variation rules for varying selected features and maintaining the static feature; and
at the processor, generating one or more variant designs according to the variation rules.

2. The method of claim 1 wherein the first vector graphic element is an icon, and the second feature is one of: size, color and image.

3. The method of claim 1 wherein the first vector graphic element is text, and the second feature is one of: size, color and font.

4. The method of claim 1 wherein the first vector graphic element is a monogram and the second feature is one of: size, color and style.

5. The method of claim 1 wherein the first vector graphic element is a container and the second feature is one of size, color, and image.

6. The method of claim 1 wherein the first feature is one of: color and layout.

7. The method of claim 1 wherein generating the base design comprises:
defining the main canvas;
defining the first vector graphic element;
applying a scaling factor to the first vector graphic element;
adjusting color of the main canvas and the first vector graphic element according to a contrast ratio; and
applying positioning constraints to the first vector graphic element.

8. The method of claim 1 wherein generating a variant design comprises:
defining a variant canvas based on the main canvas of the base design, and according to the variation rules;
defining at least one variant vector graphic element based on the first vector graphic element of the base design, and according to the variation rules;
applying a scaling factor to the at least one variant vector graphic element according to the variation rules;
adjusting color of the variant canvas and the at least one variant vector graphic element according to a contrast ratio and according to the variation rules; and
applying positioning constraints to the at least one variant vector graphic element according to the variation rules.

9. The method of claim 1 further comprising receiving a data transmission containing:
component information for defining components of the base design and the variant designs; and
a control application for (i) generating the base design and the variant designs and (ii) defining the variation rules.

10. A non-transitory computer readable medium storing a computer program, wherein execution of the computer program is for:
generating a base design having a main canvas and a first vector graphic element, the main canvas having a first feature, and the first vector graphic element having a second feature;
receiving a selection defining (i) selected features to be varied, and (ii) static features to be maintained;
defining variation rules for varying the selected features and maintaining the static features; and
generating one or more variant designs according to the variation rules.

11. The non-transitory computer readable medium of claim 10 wherein the first vector graphic element is an icon and the second feature is one of: size, color and image.

12. The non-transitory computer readable medium of claim 10 wherein the first vector graphic element is text and the second feature is one of: size, color and font.

13. The non-transitory computer readable medium of claim 10 wherein the first vector graphic element is a monogram and the second feature is one of: size, color and style.

14. The non-transitory computer readable medium of claim 10 wherein the first feature is one of color and layout.

15. The non-transitory computer readable medium of claim 10, wherein execution of the computer program is for:
generating the base design by:
defining the main canvas;
defining the first vector graphic element;
applying a scaling factor to the first vector graphic element;
adjusting color of the main canvas and the first vector graphic element according to a contrast ratio; and
applying positioning constraints to the first vector graphic element.

16. The non-transitory computer readable medium of claim 10, wherein execution of the computer program is for:
generating a variant design by:
defining a variant canvas based on the main canvas of the base design and according to the variation rules;
defining at least one variant vector graphic element based on the first vector graphic element of the base design and according to the variation rules;
applying a scaling factor to the at least one variant vector graphic element according to the variation rules;
adjusting color of the variant canvas and the at least one variant vector graphic element according to a contrast ratio and according to the variation rules; and
applying positioning constraints to the at least one variant vector graphic element according to the variation rules.

17. A method of applying positioning constraints to a first vector graphic element in a vector graphic files comprising:
defining a root layout having at least one root row and at least one root column defining root cells;
assigning the first vector graphic element to a first parent cell selected from the root cells; and
instructing the first vector graphic element to be aligned within the first parent cell.

18. The method of claim 17 further comprising:
assigning a second vector graphic element to a second parent cell selected from the root cells, wherein the first parent cell is distinct from the second parent cell.

19. The method of claim 17 further comprising defining a node layout within a root cell, the node layout having at least one node row and at least one node column defining node cells, wherein the parent cell of the first vector graphic element is selected from the root cells and the node cells.

20. The method of claim 19 further comprising:
assigning a second vector graphic element to a second parent cell selected from the root cells and the node cells, wherein the first parent cell is distinct from the second parent cell; and
instructing the second vector graphic element to be aligned within the second parent cell.

21. The method of claim 17, further comprising receiving an alignment indication, and wherein the instructing comprises instructing the first vector graphic element to be aligned within the first parent cell according to the alignment indication.

22. The method of claim 21, wherein the instructing further comprises:
calculating X,Y coordinates for the first vector graphic element according to dimensions of the first vector graphic element and dimensions of the first parent cell and according to the alignment indication; and
applying the X,Y coordinates as a transform property of the first vector graphic element.

23. A non-transitory computer readable medium storing a computer program, wherein execution of the computer program is for:
applying positioning constraints to vector graphic files by:
defining a root layout having at least one root row and at least one root column defining root cells;
assigning a first parent cell to the first vector graphic element, the parent cell selected from the root cells; and
instructing the first vector graphic element to be aligned within the first parent cell.
